(19) United States
(12) Patent Application Publication
(10) Pub. No.: US 2016/0034646 A1
(43) Pub. Date: Feb. 4, 2016

(54) SYSTEMS AND METHODS FOR ELECTRONIC MEDICAL CHARTING

(71) Applicant: Marshfield Clinic Health System, Inc., Marshfield, WI (US)

(72) Inventors: Amit Acharya, Marshfield, WI (US); James R. Kane, Marshfield, WI (US)

(21) Appl. No.: 14/882,693

(22) Filed: Oct. 14, 2015

Related U.S. Application Data
(63) Continuation-in-part of application No. 14/779,408, filed on Sep. 23, 2015.
(60) Provisional application No. 61/808,871, filed on Apr. 5, 2013.
(60) Provisional application No. 61/876,242, filed on Sep. 11, 2013.

(51) Int. Cl. G06F 19/00

(52) U.S. Cl. CPC G06F 19/322

(57) ABSTRACT

One aspect of the present disclosure relates to a system that can enter clinical data on an electronic medical chart. A graphical data input can be received from an ink-over interface. The graphical data input can include an annotation associated with a portion of a patient's body. Information associated with the annotation can be determined based on information stored in a recognition engine and stored as structured data associated with the portion of the patient's body in an electronic health record.

### RELATED APPLICATIONS

This application is a Continuation-in-Part of U.S. patent application Ser. No. 14/779,408, filed Sep. 23, 2015, entitled “Systems and Methods for Tooth Charting”, which is a U.S. National Stage filing under 35 USC 371, claiming priority to Serial No. PCT/US2014/032601, filed Apr. 2, 2014, and also claims the benefit of U.S. Provisional Application No. 61/808,871, filed Apr. 5, 2013 and U.S. Provisional Application No. 61/876,242, filed Sep. 11, 2013, both entitled “Intelligent Tooth Charting Interface”. These applications are hereby incorporated by reference in their entirety for all purposes.

### TECHNICAL FIELD

The present disclosure relates generally to systems and methods for computer-based medical charting and, more specifically, to systems and methods for computer-based medical charting employing an ink-over interface with structured data capture.

### BACKGROUND

A medical chart can provide a comprehensive, standardized, graphical view of clinical data (e.g., diagnostic information and/or therapeutic information) related to at least one area of a patient's body. Traditional medical charts have employed a pen and paper interface that allows medical professionals to make the annotations in locations approximating clinical reality (e.g., the annotation can be made in the proper spatial orientation). However, as the medical community has embraced the digital world (e.g., electronic medical records), traditional pen and paper interfaces have become obsolete. Electronic medical charts have been developed with keyboard and mouse interfaces to meet the demands of the digital world. However, the keyboard and mouse interfaces allow for imprecise annotations that do not approximate clinical reality. Additionally, medical professionals can find the keyboard and mouse interface cumbersome to document clinical findings and treatment planning.

### SUMMARY

The present disclosure relates generally to systems and methods for computer-based medical charting and, more specifically, to systems and methods for computer-based medical charting employing an ink-over interface with structured data capture. The ink-over interface allows an input that resembles a traditional pen and paper interface, while providing the computational abilities of the digital world. The structured data capture allows the input to be stored and categorized in a structured format (e.g., for categorization in an electronic health record (EHR) of a patient).

In one aspect, the present disclosure can include a system that can enter clinical data on an electronic medical chart. The system can include a non-transitory memory storing computer-executable instructions and a processor that executes the computer-executable instructions to at least: receive a graphical data input from an ink-over interface, wherein the graphical data input comprises an annotation associated with at least a portion of a patient's body displayed by the electronic medical chart; perform optical symbol recognition to identify the annotation; determine information associated with the annotation based on information stored in a recognition engine; and store the information associated with the annotation as structured data associated with the at least the portion of the patient's body in an electronic health record.

In another aspect, the present disclosure can include a method for entering clinical data into an electronic medical chart. The method can include steps that can be performed by a system that includes a processor. The steps can include: receiving a graphical data input from an ink-over interface, wherein the graphical data input comprises an annotation associated with at least a portion of a patient's body displayed by the electronic medical chart; performing optical symbol recognition to identify the annotation; determining information associated with the annotation based on information stored in a recognition engine; and storing the information associated with the annotation as structured data associated with the at least the portion of the patient's body in an electronic health record.

In a further aspect, the present disclosure can include an electronic medical charting system. The electronic medical charting system can include an ink-over interface and a computing device associated with the ink-over interface. The ink-over interface can be configured to receive a graphical data input comprising an annotation associated with at least a portion of a patient's body. The computing device can include a non-transitory memory storing computer-executable instructions; and a processor that executes the computer-executable instructions to at least: detect a gesture associated with the ink-over interface; receive the graphical data input from the ink-over interface based on detection of the gesture; perform optical symbol recognition to identify an annotation within the graphical data input; determine information associated with the annotation based on information stored in a recognition engine; and store the information associated with the annotation as structured data associated with the at least the portion of the patient's body in an electronic health record.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic block diagram showing an example of a computing device that can be used for electronic medical charting in accordance with an aspect of the present disclosure;

FIG. 2 is a schematic block diagram showing a system for electronic medical charting, which can be employed by the computing device shown in FIG. 1;

FIG. 3 is a state diagram for the receipt of graphical data information by the system shown in FIG. 2;

FIG. 4 is a state diagram for the identification of the annotation by the system shown in FIG. 2;

FIG. 5 is a process flow diagram illustrating a method for detecting annotations entered via an ink-over interface in accordance with another aspect of the present disclosure; and

FIG. 6 is a process flow diagram illustrating a method for electronic medical charting employing an ink-over interface in accordance with another aspect of the present disclosure.

### DETAILED DESCRIPTION

### I. Definitions

In the context of the present disclosure, the singular forms “a,” “an” and “the” can also include the plural forms, unless the context clearly indicates otherwise.

The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “medical charting” can refer to a process in which a medical professional lists and describes information related to the health of at least a portion of a patient's body. The information can be graphically summarized and organized on a medical chart. In some instances, the information can include diagnostic information and/or therapeutic information.

As used herein, the term “medical chart” can refer to a graphical tool that presents a comprehensive view of at least a portion of a patient's body and information related to the health of the at least the portion of the patient's body. The information can be displayed, for example, via annotations.

As used herein, the terms “electronic” and “computer-based” when used in connection with “medical charting” and “medical chart” can refer to data entry corresponding to the “medical charting” and “medical chart” being performed using a computing device that includes at least a non-transitory memory.

As used herein, the terms “electronic health record (EHR)” and “electronic medical record” can refer to a digital version of a patient's paper medical chart. The EHR can be stored in a repository that is accessible to different medical professionals associated with the patient.

As used herein, the term “annotations” can refer to diagrammatic indications on at least a portion of a patient's body chart that reflect the information related to the health of at least a portion of a patient's body in a standardized manner. The standardized annotations can include text, numbers, and/or symbols in different colors, where specific combinations of text, numbers, symbols, and colors can represent different conditions. The standardization allows the annotations to be understood by different medical professionals (either specific to a certain specialty or uniform across specialties).

As used herein, the term “interface” can refer to software and/or hardware that allow a user (e.g., a medical professional) to communicate with a computing device.

As used herein, the term “ink-over interface” can refer to a software or hardware interface that allows a user (e.g., a medical professional) to enter graphical data input to a computing device. The graphical data input can be written and/or drawn in one or more colors on the ink-over interface using an input device. In some instances, an ink-over interface can be implemented on a touch screen device (e.g., a tablet computing device, a smart phone device, a laptop computing device, etc.) and the input device can be a stylus, a finger, or the like.

As used herein, the term “graphical data input” can refer to an input on an ink-over interface including one or more annotations. In some instances, the graphical data input can be initiated and/or ended based on one or more gestures on the ink-over interface.

As used herein, the term “structured data” can refer to data that resides in a fixed field within a stored record (e.g., a relational database). In some instances, structured data can include data related to an annotation, such as a condition, a procedure, a medical history, a medical professional's name, etc.

As used herein, the term “medical professional” can refer to a person involved in a medical exam or procedure that can employ a medical chart, including, but not limited to, doctors, physicians assistants, nurse practitioners, nurses, medical students, and other medical staff.

As used herein, the term “patient” can refer to any warm-blooded organism including, but not limited to, a human being, a pig, a rat, a mouse, a dog, a cat, a goat, a sheep, a horse, a monkey, an ape, a rabbit, a cow, etc.

### II. Overview

The present disclosure relates generally to systems and methods for electronic medical charting and, more specifically, to systems and methods for electronic medical charting employing an ink-over interface with structured data capture. The ink-over interface allows an input that resembles a traditional pen and paper interface, while providing a link to the digital world. The systems and methods of the present disclosure can solve problems inherent to electronic medical charting with keyboard and mouse interfaces that can are not intuitive and provide imprecise annotations. In contrast to traditional electronic medical charting, the systems and methods of the present disclosure provide an intuitive ink-over interface (e.g., analogous to traditional pen and paper interfaces) for entry of standardized annotations, while also meeting the existing information needs of medical professionals (e.g., by employing optical symbol recognition and a recognition engine to create structured data related to the annotations). The electronic medical chart of the present disclosure can be used for medical record documentation (e.g., in the patient's EHR). Examples of fields where the systems and methods of the present disclosure can be used include podiatry (e.g., for charting diabetic foot assessments), dermatology (e.g., for charting skin lesions), and ophthalmology (e.g., for annotation of retinal health).

### III. Systems

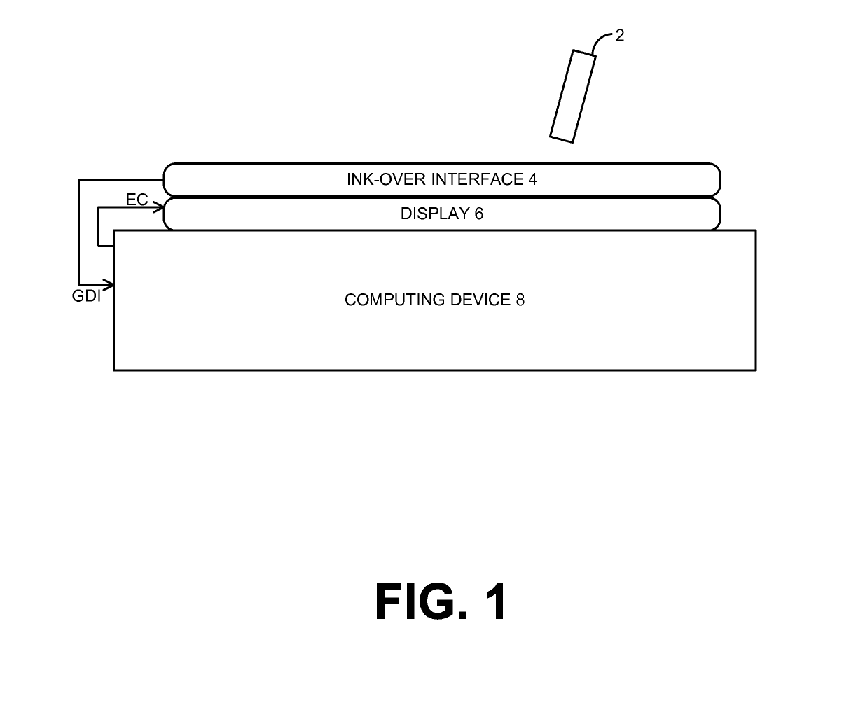

One aspect of the present disclosure can include a system for computer-based medical charting. One example of such a system is shown in FIG. 1, which illustrates a computing device 8 that includes an ink-over interface 4 that can be used for computer-based medical charting. The ink-over interface 4 can facilitate annotating an electronic medical chart, allowing medical professionals to enter annotations directly over the electronic medical chart (similarly to the interaction with a pen and paper interface). The annotations can, for example, be standardized test, numbers, or symbols that can document an existing condition, diagnostic information, therapeutic information, and/or planned treatment information. The annotations can be interpreted and stored by the computing device 8 as structured data, rather than stored as a static image. For example, the annotations can be interpreted by the computing device 8 according to an optical symbol recognition technique and data related to the annotations can be retrieved from a recognition engine to create structured data related to the annotations that can be stored in connection to the electronic medical chart (e.g., in an electronic health record for the patient).

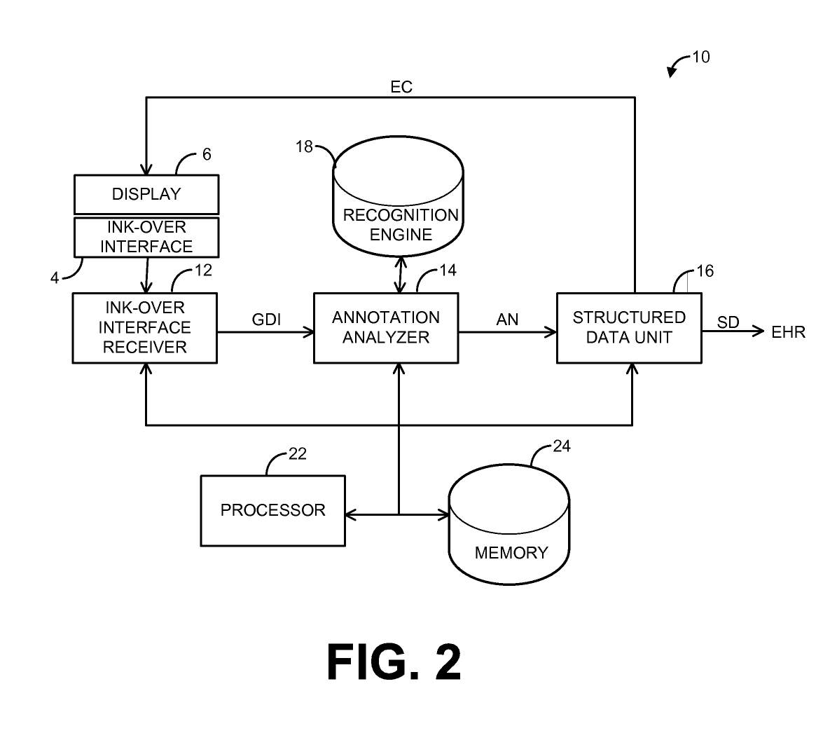

FIG. 1, as well as associated FIG. 2, is schematically illustrated as block diagrams with the different blocks representing different components. The functions of one or more of the components can be implemented by computer program instructions. The computer program instructions can be provided to a processor of the computing device 8 to produce a machine, such that the instructions, which execute via the processor, can create a mechanism for implementing the functions of the components specified in the block diagrams.

The computer program instructions can also be stored in a non-transitory computer-readable memory that can direct the computing device 8 to function in a particular manner, such that the instructions stored in the non-transitory computer-readable memory produce an article of manufacture including instructions, which implement the functions specified in the block diagrams and associated description.

The computer program instructions can also be loaded onto the computing device 8 to cause a series of operational steps to be performed to produce a computer-implemented process such that the instructions that execute on the computing device 8 provide steps for implementing the functions of the components specified in the block diagrams and the associated description.

Accordingly, functionalities of the computing device 8 and/or the system 10 can be embodied at least in part in hardware and/or in software (including firmware, resident software, micro-code, etc.). Furthermore, aspects of the computing device 8 and/or the system 10 can take the form of a computer program product on a computer-usable or computer-readable storage medium having computer-usable or computer-readable program code embodied in the medium for use by or in connection with an instruction execution system. A computer-usable or computer-readable medium can be any non-transitory medium that is not a transitory signal and can contain or store the program for use by or in connection with the instruction or execution of a system, apparatus, or device. The computer-usable or computer-readable medium can be, for example but not limited to, an electronic, magnetic, optical, electromagnetic, infrared, or semiconductor system, apparatus or device. More specific examples (a non-exhaustive list) of the computer-readable medium can include the following: a portable computer diskette; a random access memory; a read-only memory; an erasable programmable read-only memory (or Flash memory); and a portable compact disc read-only memory.

As shown in FIG. 1, the computing device 8 can include at least an ink-over interface 4, a display (or display device) 6, a non-transitory memory, and a processor. For example, the computing device 8 can be a tablet computing device, a smart phone device, a personal media player device, a personal entertainment system device, a laptop computing device. The ink-over interface 4 and the display 6 can be coupled so that an annotation made using the ink-over interface (e.g., graphical data input (GDI)) can correspond with at least a portion of a patient's body and/or a location on the electronic medical chart (EDC) displayed on the display 6. The ink-over interface 4 and/or the display 6 can be implemented in hardware and/or in software. The non-transitory memory of the computing device 8 can store instructions that are executable by the processor at least to receive the graphical data input (GDI) from the ink-over interface 4 (e.g., in response to being contacted by an input device 2, such as a stylus) and/or to display an electronic medical chart (EC) on the display 6.

In some instances, the electronic medical chart can be displayed by the display 6 with one or more views of a portion of the electronic medical chart. For example, one view can include a zoomed in view of one or more portions of the patient's body from the electronic medical chart. In this case, the graphical data input can be based on a gesture that includes a symbol drawn on the zoomed in view of the portion of the patient's body at a certain location where an annotation is made or is going to be made.

FIG. 2 is a schematic block diagram showing a system 10 for computer-based medical charting that can be employed by the computing device 8 shown in FIG. 1. The ink-over interface 4 and the display 6 perform functionalities similar to those described with respect to FIG. 1. The display 6 can display the electronic medical chart (EC), and the ink-over interface can provide graphical data inputs (GDI) related to at least a portion of the electronic medical chart (EC) (e.g., related to one or more portions of the patient's body).

The electronic medical chart (EC) can be used in any field of medicine, dentistry, veterinary medicine, or the like. The respective annotations can be standard annotations that include symbols, colors, numbers, and text to document clinical conditions that are widely accepted across the field. The electronic medical chart (EC) can include patient information (e.g., name, date of birth, contact information, chronic medical conditions, a photograph, etc.).

As an example, the electronic medical chart (EC) can be used in the field of ophthalmology. An example of an electronic medical chart (EC) that can be utilized in ophthalmology can include one or more fundus drawings that can assist the medical professional's annotations. For example, various annotations (with different symbols, numbers, and text) can be made in different colors to track a record of anterior segment and/or retinal disease progress. Various annotations can be made in various colors to represent various disease states and/or treatments of the retina. The anatomic region of the eye where the medical professional has made the annotation can be automatically recognized. The annotation can be stored as structured data on the electronic medical chart (EC) or in the clinical note of the electronic health record (EHR).

In another example, the electronic medical chart (EC) can be used in the field of podiatry (e.g., to document a foot exam for an injury or diabetic issues). In this case, the palpated points and other clinical information can be charted on the foot directly through the ink-over interface. The anatomic region of the foot or skin where the medical has made the annotation can be automatically recognized. The annotation can be stored as structured data on the electronic medical chart (EC) or in the clinical note of the electronic health record (EHR).

In yet another example, the electronic medical chart (EC) can be used in the field of dermatology. For example, accepted annotations can be used when documenting a specific region, shape, and color of moles or other birth identification marks or other clinical conditions. The medical professional can chart directly onto a map of the human body. The anatomic region of these annotations can be automatically recognized, and the annotations can be captured as structured data, which can be stored in an electronic health record (EHR) of the patient.

In each of these specialties, the electronic medical chart (EC) can also include a plurality of selectable tools that can be utilized in connection with the ink-over interface 4. In some instances, the tools can include a pen tool with different selectable colors and an eraser tool. The display can also include a history (e.g., related to previous annotations on the portion of the patient's body). In some instances, the display can also include one or more x-ray images (e.g., from the electronic medical record (EHR)). The display can also include one or more actions that can be performed on the electronic medical chart (EC) (e.g., select the portion of the patient's body, annotate the portion of the patient's body, edit history of portion of the patient's body, select a different portion of the patient's body, view previous versions of the chart, etc.).

The electronic medical chart (EC) can be displayed in one or more of a plurality of different views. For example, an area of interest mode can be activated by a tap gesture on the portion of the body. An additional window can be displayed with a zoomed in version of the portion of the body (and may include additional surrounding portions of the body). For example, the zoomed in version can include a 2x zoom area of the selected portion of the patient's body. A double-tap gesture can allow the zoomed in version to be further zoomed in (e.g., 4x). An annotation can be made on the zoomed in version of the portion of the patient's body and gestures related to the annotation can be used to identify the annotation. The history related to the portion of the patient's body can be updated with structured data related to the annotation (e.g., with progress notes showing the progression of the portion of the patient's body through history).

Referring again to FIG. 2, the system 10 can include components including at least an ink-over interface receiver 12, an annotation analyzer 14, and a structured data unit 16. The components can facilitate receiving the graphical data input (GDI) from the ink-over interface 4, interpreting the graphical data input (GDI) into an annotation (e.g., a symbol, a text, and/or a color defined within the medical field or by a specialty within the medical field), and storing an interpretation of the annotation (AN) in structured data (SD). For example, the structured data can be stored in an electronic health record.

One or more of the components can include instructions that are stored in a non-transitory memory 22 and executed by a processor 24. Each of the components can be in a communicative relationship with one or more of the other components, the processor 24, and/or the non-transitory memory 22 (e.g., via a direct or indirect electrical, electromagnetic, optical, or other type of wired or wireless communication) such that an action from the respective component causes an effect on one or more of the other components and/or on the electronic medical chart (EC).

The ink-over interface receiver 12 can be configured to receive a graphical data input (GDI) from an ink-over interface 4. In some instances, the graphical data input (GDI) can include an annotation associated with one or more portions of the patient's body on a medical chart. For example, the annotation can include one or more of: a location on the portion of the patient's body associated with the annotation, information related to an existing condition, diagnostic information, therapeutic information, and information related to a planned treatment or procedure. In some instances, the annotation can relate to a previous diagnosis, treatment, or procedure.

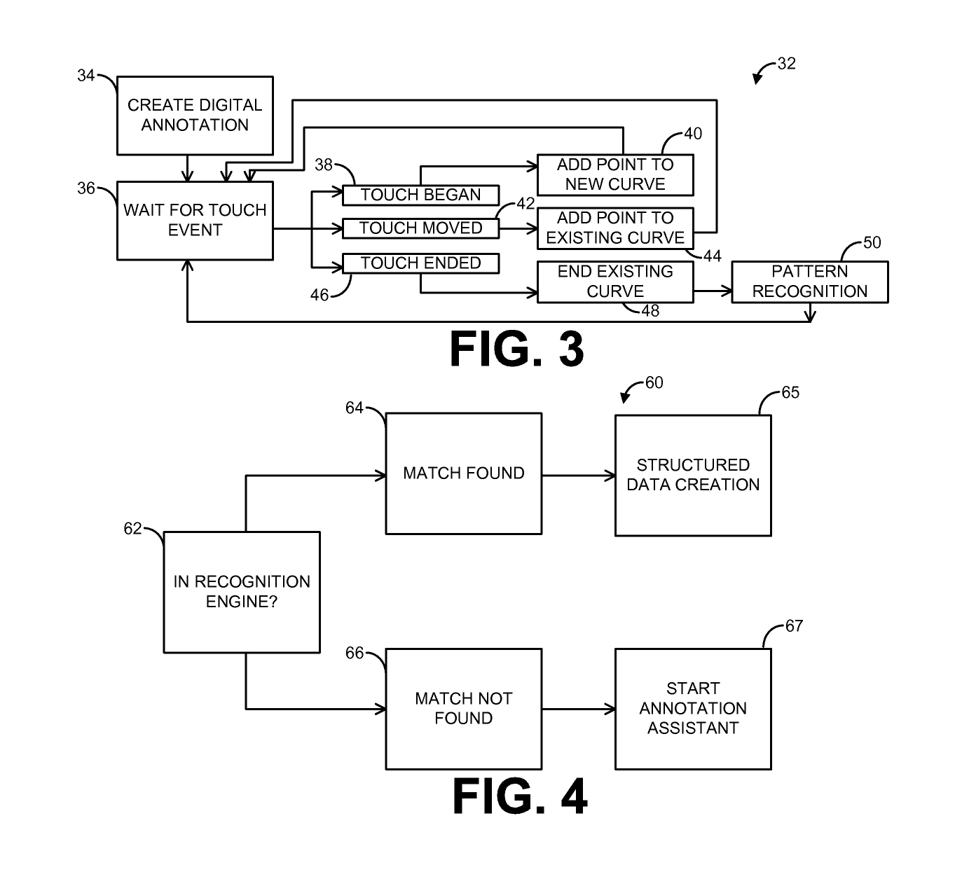

A state diagram 32 showing the operation of the ink-over interface receiver 12 in the receipt of graphical data information (GDI) is illustrated in FIG. 3. At element 34, a digital annotation can be created in response to the system 10 entering an annotation state (e.g., by selection of an annotation operation). In some instances, the ink-over interface receiver 12 can detect various touch events by polling an operating system associated with the computing device 8. At element 36, the ink-over interface receiver 12 can wait for a touch event. Upon receiving a beginning touch event (e.g., at element 38), the ink-over interface receiver 12 can add a point associated with the beginning touch event to a new curve (e.g., at element 40). Then, the ink-over interface receiver 12 can wait for a new touch event. Upon detection of a new touch event moved from the beginning touch event (e.g., at element 42), the ink-over interface receiver 12 can add the new point to the existing curve (e.g., at element 44) and wait for the next touch event. When there are no more touch events (e.g., at element 46) after a period of time (e.g., one second or more), the ink-over interface receiver 12 can end the existing curve (e.g., at element 48). When the ink-over interface receiver 12 ends the existing curve, the resulting annotation can be sent to the annotation analyzer 14 for pattern recognition (e.g., at element 50) and/or further processing. A number of different annotations that can be part of the graphical data input (GDI) based on the governing medical convention.

Referring again to FIG. 2, the annotation analyzer 14 can be configured to determine information associated with the annotation (AN) based on information stored in a recognition engine 18. The annotation can be associated with at least a portion of a patient's body or a plurality of portions of the patient's body. For example, the annotation analyzer 14 can employ an optical symbol recognition technique identify the annotation (e.g. the symbol, the text, and/or the color) from the graphical data input (GDI). The annotation identified by the optical symbol recognition can be compared to information stored in the recognition engine 18 (e.g., information associated with the combination of the symbol, the text, and/or the color) to determine the information associated with the annotation (AN). In some instances, the recognition engine 18 can be located within the computing device 8 of FIG. 1. In other instances, at least a portion of the recognition engine 18 can be located remote from the computing device 8.

FIG. 4 is a state diagram 60 of the identification of the annotation by the annotation analyzer 14. When the annotation is passed to the annotation analyzer 14 by the ink-over interface receiver 12, the annotation analyzer can determine if the annotation matches stored information within the recognition engine 18 (e.g., at element 62). If the match is found (e.g., at element 64), structured data (SD) related to the annotation can be created (e.g., at element 65) by the structured data unit 16 from information associated with the identified annotation (e.g., stored in the recognition engine 18). In some instances (e.g., when the annotation matches a lesser-known pattern), the annotation can be passed to a progress note creator that allows the medical professional to enter the associated structured data (SD) (e.g., by selecting one or more procedures and/or diagnoses associated with the annotation).

If a match for the annotation is not found in the recognition engine 18 (e.g., at element 66), the annotation can be moved to a pattern failed state. The annotation analyzer 14 can prompt the medical professional to complete the annotation correctly by starting an annotation assistant (e.g., at element 67). The annotation assistant can prompt the medical professional to clear the current annotation, persist with the image as unstructured data, and/or make recommendations to guide the medical professional to an alternate means of creating the structured data (SD).

Referring again to FIG. 2, the structured data unit 16 can be configured to store the information associated with the annotation (AN) as structured data (SD). The structured data (SD) can be associated with the at least the portion of the patient's body associated with the annotation. In some instances, the structured data (SD) can persist with the associated at least the portion of the patient's body with the electronic medical chart (EC) (e.g., as a progress note). The structured data can be populated based on information associated with the identified annotation and/or based on a selection of a progress state from a set of potential progress states associated with the annotation. The structured data (SD) can persist between different views associated with the electronic medical chart and with different access times of the electronic medical chart (EC) (e.g., providing a medical history for the associated patient that can be accessed at different medical appointments). In some instances, the structured data can be presented across different times starting with the most recent progress note. For example, if the portion of the patient's body has been removed (e.g., a tumor removed, a toe amputated, etc.), the previous progress notes can be deleted.

When the structured data is accepted as associated with the portion of the patient's body, it can persist with the portion of the patient's body (e.g., through different views, different zoom levels, different charts, and the like). In some instances, the structured data can be stored in an electronic health record (EHR). The electronic health record (EHR) can include additional information that can provide a complete medical history for the patient (e.g., x-rays). In other instances, the structured data can be included in the electronic medical chart (EC). The electronic medical chart (EC) can be transmitted to the display 6 and the structured data (SD) can be visually displayed with the rest of the electronic medical chart (EC).

### IV. Methods

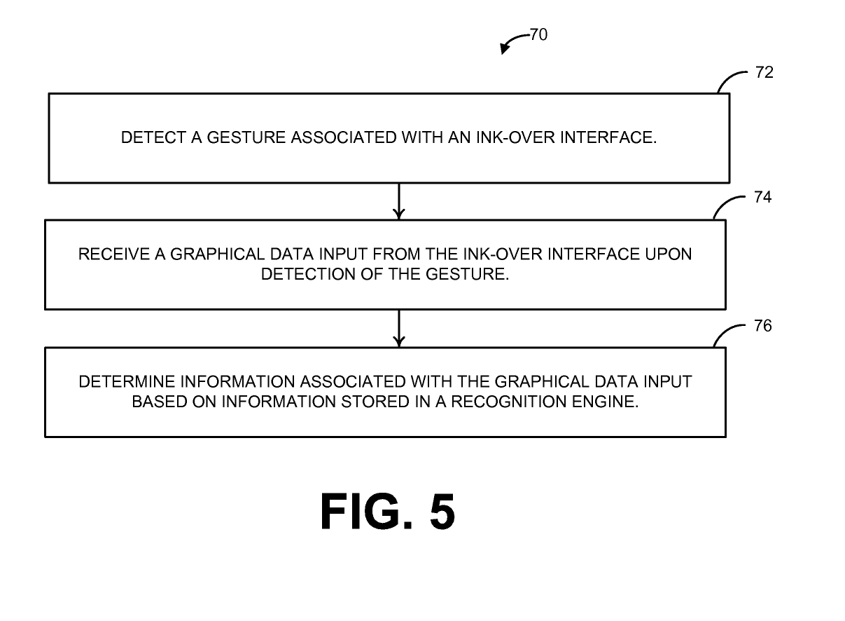

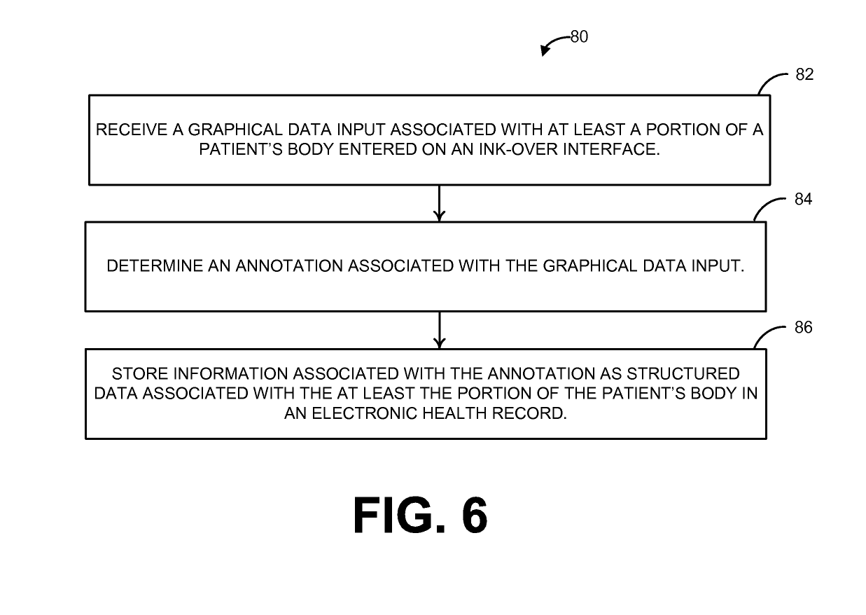

Another aspect of the present disclosure can include a method for electronic medical charting. An example of a method 70 that can detect annotations entered via an ink-over interface is shown in FIG. 5. Another example of a method 80 for computer-based medical charting employing an ink-over interface is shown in FIG. 6.

The methods 70 and 80 of FIGS. 5 and 6, respectively, are illustrated as process flow diagrams with flowchart illustrations. For purposes of simplicity, the methods 70 and 80 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 70 and 80.

One or more blocks of the respective flowchart illustrations, and combinations of blocks in the block flowchart illustrations, can be implemented by computer program instructions. The computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, the steps/acts can be implemented by a system comprising a processor that can access the computer-executable instructions that are stored in a non-transitory memory.

The methods 70 and 80 of the present disclosure may be embodied in hardware and/or in software (including firmware, resident software, micro-code, etc.). Furthermore, aspects of the present disclosure may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain or store the program for use by or in connection with the instruction or execution of a system, apparatus, or device.

Referring to FIG. 5, an aspect of the present disclosure can include a method 70 for detecting annotations (e.g., symbols, text, and/or colors) entered via an ink-over interface (e.g., ink-over interface 4). A gesture associated with the ink-over interface can be detected (e.g., by ink-over interface receiver 12) at step 72. The gesture can define a graphical data input (GDI) that is analyzed for the associated annotation. For example, in annotation state, various touch events can be detected (e.g., by ink-over interface receiver 12) by polling an operating system of an associated computing device (e.g., computing device 8). Upon receiving a beginning touch event a point associated with the beginning touch event can be added to a new curve. Upon detection of a new touch event moved from the beginning touch event, additional new points can be added to the existing curve until no more touch events are received (e.g., after a period of time or after an indication that the annotation is complete).

At step 74, a graphical data input (GDI) can be received (from ink-over interface receiver 12 at annotation analyzer 14) from the ink-over interface upon detection of the gesture. The graphical data input can include the completed annotation. At 76, information associated with the graphical data input (GDI) can be determined (e.g., based on a pattern recognition process by annotation analyzer 14) based on information stored in a recognition engine (e.g., recognition engine 18).

The information associated with the graphical data input (GDI) can be used to create structured data associated with the annotation (e.g., by structured data unit 16). For example, the received annotation can undergo a pattern recognition process to match the annotation to stored information (e.g., within the recognition engine 18). If a match is found, structured data (SD) related to the annotation can be created (e.g., by structured data unit 16) from information associated with the identified annotation (e.g., stored in the recognition engine 18). In some instances (e.g., when the annotation matches a lesser-known pattern), the medical professional can select one or more procedures and/or diagnoses associated with the annotation to create the associated structured data. If a match for the annotation cannot be found (e.g., within recognition engine 18), the medical professional can be prompted to complete the annotation correctly (e.g., prompt the medical professional to clear the current annotation, persist the image as unstructured data, and/or make recommendations to guide the medical professional to an alternate means of creating the structured data (SD)).

Referring now to FIG. 6, another aspect of the present disclosure can include a method 80 for computer-based medical charting employing an ink-over interface (e.g., ink-over interface 4). Steps 82-84 are similar to steps 72-76 of the method 70 illustrated in FIG. 5. For example, at step 82, a graphical data input (GDI) associated with at least a portion of a patient's body can be received (e.g., by ink-over interface receiver 12) from an ink-over interface (e.g., ink-over interface 4). At step 84, an annotation associated with the graphical data input (GDI) can be determined (e.g., by annotation analyzer 14). Based on the determination, information associated with the annotation can be retrieved (e.g., from recognition engine 18 and/or entered by a medical professional). The information associated with the annotation can be stored as structured data (SD) associated with the at least the portion of the patient's body (e.g., by structured data unit 16) at step 86. The structured data (SD) can persist with the at least the portion of the patient's body through different views and/or through time.

From the above description, those skilled in the art will perceive improvements, changes and modifications. Such improvements, changes and modifications are within the skill of one in the art and are intended to be covered by the appended claims.

What is claimed is:

1. A system that enters clinical data on an electronic medical chart, the system comprising:
a non-transitory memory storing computer-executable instructions; and
a processor that executes the computer-executable instructions to at least:
receive a graphical data input from an ink-over interface, wherein the graphical data input comprises an annotation associated with at least a portion of a patient's body displayed by the electronic medical chart;
perform optical symbol recognition to identify the annotation;
determine information associated with the annotation based on information stored in a recognition engine; and
store the information associated with the annotation as structured data associated with the at least the portion of the patient's body in an electronic health record.

2. The system of claim 1, wherein optical symbol recognition is triggered by a gesture made on an ink-over interface that is associated with the graphical data input.

3. The system of claim 1, wherein the annotation represents at least one of an existing condition, a diagnosis, therapeutic information, a planned treatment, a planned procedure, and a previous procedure.

4. The system of claim 1, wherein the performing the optical signal recognition comprises determining at least one of a symbol of the annotation and a color of the annotation; and
wherein the information associated with the annotation is determined based on the at least one of the symbol and the color that is stored in the recognition engine.

5. The system of claim 1, wherein the annotation comprises at least one of a symbol, a number, and text entered over a graphic of the electronic medical chart.

6. The system of claim 1, wherein the medical chart is at least one of an ophthalmological chart, a podiatric chart, and a dermatological chart.

7. The system of claim 1, wherein the processor executes the computer-executable instructions to:
display the portion of the patient's body on a display device; and
receive the graphical data input from the ink-over interface associated with the display device,
wherein the graphical data input is associated with a location on the portion of the patient's body.

8. The system of claim 7, wherein the portion of the patient's body is displayed on the display device associated with a view of the portion of the patient's body; and
wherein the view of the at least the portion of the patient's body is one of a plurality of views of the portion of the patient's body.

9. The system of claim 8, wherein the structured data associated with the portion of the patient's body persists with the portion of the patient's body and is displayed in each of the plurality of views of the portion of the patient's body.

10. A method for entering clinical data on an electronic medical chart, the method comprising the steps of:
receiving, by a system comprising a processor, a graphical data input from an ink-over interface, wherein the graphical data input comprises an annotation associated with at least a portion of a patient's body;
performing optical symbol recognition to identify the annotation;
determining information associated with the annotation based on information stored in a recognition engine; and
storing the information associated with the annotation as structured data associated with the at least the portion of the patient's body in an electronic health record.

11. The method of claim 10, further comprising:
displaying, by the system, the electronic medical chart on a display device;
detecting, by the system, a gesture on the ink-over interface; and
receiving, by the system, the graphical data input based on the gesture.

12. The method of claim 11, wherein the displaying the portion of the patient's body further comprises:
receiving a selection of the at least the portion of the patient's body from the electronic medical chart; and
displaying the at least the portion of the patient's body in a separate window from the electronic medical chart.

13. The method of claim 10, wherein the recognition engine stores information related to symbols, colors, and definitions related to the annotation.

14. The method of claim 10, wherein the medical chart is at least one of an ophthalmological chart, a podiatric chart, and a dermatological chart.

15. The method of claim 10, wherein the annotation comprises at least one of a symbol, a number, and text entered over a graphic of the electronic medical chart.

16. An electronic medical charting system, comprising:
an ink-over interface configured to receive a graphical data input comprising an annotation associated with at least a portion of the patient's body;
a computing device associated with the ink-over interface, comprising:
a non-transitory memory storing computer-executable instructions; and
a processor that executes the computer-executable instructions to at least:
detect a gesture associated with the ink-over interface;
receive the graphical data input from the ink-over interface based on detection of the gesture;
perform optical symbol recognition to identify an annotation within the graphical data input;
determine information associated with the annotation based on information stored in a recognition engine; and
store the information associated with the annotation as structured data associated with the at least the portion of the patient's body in an electronic health record.

17. The electronic medical charting system of claim 16, wherein structured data persists with the portion of the patient's body through each of a plurality of views of the portion of the patient's body.

18. The electronic medical charting system of claim 16, wherein the annotation comprises at least one of a symbol, a number, and text entered over a graphic of the electronic medical chart.

19. The electronic medical charting system of claim 16, further comprising a display device coupled to the ink-over interface and associated with the computing device.

20. The electronic medical charting system of claim 19, wherein the display device is configured to display the electronic medical chart and at least one view of a selected at least the portion of the patient's body.
